(19) United States
(12) Patent Application Publication
(10) Pub. No.: US 2026/0100119 A1
(43) Pub. Date: Apr. 9, 2026

(54) PHOTO CHAMBER WITH LIGHT SHROUDS

(71) Applicant: Microchip Technology Incorporated, Chandler, AZ (US)

(72) Inventors: Patrick McFarland, Gilbert, AZ (US); Arthur B. Eck, Gilbert, AZ (US); Jonathan Corbett, Havertown, PA (US)

(73) Assignee: Microchip Technology Incorporated, Chandler, AZ (US)

(21) Appl. No.: 19/056,286

(22) Filed: Feb. 18, 2025

Related U.S. Application Data
(60) Provisional application No. 63/704,065, filed on Oct. 7, 2024.

(51) Int. Cl. G08B 17/107; G01N 21/53

(52) U.S. Cl. CPC G08B 17/107; G01N 21/532; G01N 2201/022

(57) ABSTRACT

Various examples of the teachings herein include monitoring systems. An example system includes: a housing defining an internal test chamber; a sensor element exposed to the internal test chamber to generate a signal representing an illuminance; one or more passageways allowing air flow into the internal test chamber from a surrounding area; and a shroud blocking entrance of light into the internal test chamber through the one or more passageways along a dominant interference path to reduce noise in the illuminance signal.

### RELATED APPLICATIONS

This application claims priority to U.S. Provisional Patent Application No. 63/704,065 filed Oct. 7, 2024, the contents of which are hereby incorporated in their entirety.

### TECHNICAL FIELD

The present disclosure relates to monitoring systems. Various examples of the teachings herein include systems and/or methods for reducing interference in monitoring systems, e.g. smoke detectors.

### BACKGROUND

In the field of electronic devices including monitors and sensors, the signal to noise ratio generated by the sensors affects device performance. The operation of environmental sensors such as smoke detectors and other life safety monitors may be compromised by increases in the amount of noise in any given signal. The baseline amount of noise may be referred to as a “noise floor”. The higher the noise floor for a given monitoring system, the more amplification and/or signal processing is required including, but not limited to, larger driver circuits, extra batteries, or power loops.

Some smoke detectors employ a light sensor to measure light reflected by smoke particles present in a darkened test chamber to indicate the presence of smoke. This may include generating light in one part of the smoke detector and measuring it in another. Extraneous light impinging on the light sensor interferes with accurate sensing, creating increased noise. To avoid this, these smoke detectors include a housing with baffles allowing smoke particles to enter the test chamber but reducing the entry of external light.

For the purposes of this disclosure, a monitor refers to an electronic device which monitors one or more conditions, such as a smoke detector or a thermostat. A sensor or sensor element refers to a specific element within such a monitor to detect a particular parameter or condition.

### BRIEF DESCRIPTION OF THE DRAWINGS

FIG. 1 is a drawing illustrating a portion of an example system incorporating teachings of the present disclosure;

FIG. 2 is a drawing illustrating a portion of an example system incorporating teachings of the present disclosure;

FIG. 3 is a drawing of internal components of an example system incorporating teachings of the present disclosure;

FIG. 4 is a drawing of internal components of an example system incorporating teachings of the present disclosure;

FIG. 5 is a drawing of internal components of an example system incorporating teachings of the present disclosure; and

FIGS. 6-13 are schematic drawings of internal components of example systems incorporating teachings of the present disclosure.

### DETAILED DESCRIPTION

Examples of the teachings herein include monitoring systems with shrouds deployed to reduce the effect of external light sources on a sensor element in a test chamber. The teachings of the present disclosure may be used to reduce the amount of light entering the test chamber of a monitoring system, e.g., a smoke detector. The performance of a smoke detector or any other monitoring system affected by incident light suffers due to an increase in the noise as a result of light from outside the test chamber impinging on the sensor element. Although a completely light-tight test chamber may offer the lowest chance of any such light reaching the sensor element, it would also stop smoke particles from entering and render the monitoring system ineffective for its purpose.

The shrouds described in this disclosure may, instead, be added along a particular axis of interest. Analysis of test chambers for light detecting smoke detectors shows specific dominant direct and reflected light interference paths can be identified. If light approaching the sensor element along one of these axes of interest is blocked, this can reduce the total amount of noise generated by operation of the sensor element, reducing the overall noise affecting the monitoring system. To date, the design of housings for smoke detectors has typically treated the airflow requirements as primary and not accounted for dominant light interference paths. A system with a design balancing these concerns may include shrouds along the dominant light interference paths, whether direct or reflected, but which do not otherwise reduce the airflow capacity of the baffles or passageways.

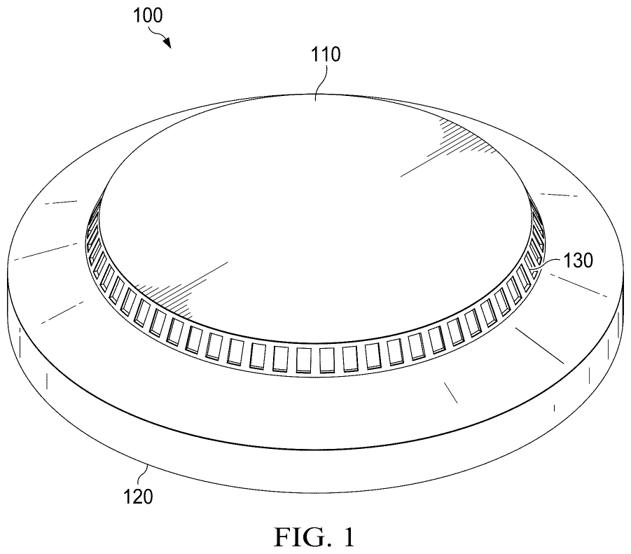

FIG. 1 illustrates an example monitoring system 100 incorporating teachings of the present disclosure. The monitoring system 100 includes an external housing top 110, an external housing bottom 120, and vents 130 allowing fluid flow into an interior defined between the external housing top 110 and the external housing bottom 120.

The monitoring system 100 may include one or more sensors, e.g., a smoke detector. In the example shown in FIG. 1, the monitoring system 100 includes an external housing bottom 120 to mount the system 100 to a wall or ceiling. In practice, the external housing bottom 120 may be mounted at the top of the system 100, e.g., mounted to the ceiling so the external housing top 110 actually hangs from the external housing bottom 120. In another example, the external housing bottom 120 may be mounted to a wall so the entire monitoring system 100 is rotated ninety degrees from the orientation shown in FIG. 1. The terms “top” and “bottom” are used relative to the orientation shown in FIG. 1 but do not limit the use of the components in practice.

As shown in FIG. 1, the external housing top 110 includes vents 130 to allow fluid flow into an interior space of the system 100. In practice, the vents 130 may be in any part of the housing, including the external housing bottom 120, or both. In practice, the vents 130 may be defined between two parts of the external housing.

The monitoring system 100 may include one or more sensor elements. The sensor elements may monitor any appropriate parameter and may operate under any appropriate scheme, including without limitation by measuring a capacitance, a current, a resistance, etc. The one or more sensor elements may be exposed to any air flow within a test chamber 110 and may, therefore, depend on air flow through the vents 130. In such a case, any blockage or impediment to air flow through the vents 130 may reduce the accuracy and/or efficiency of the monitoring system 100.

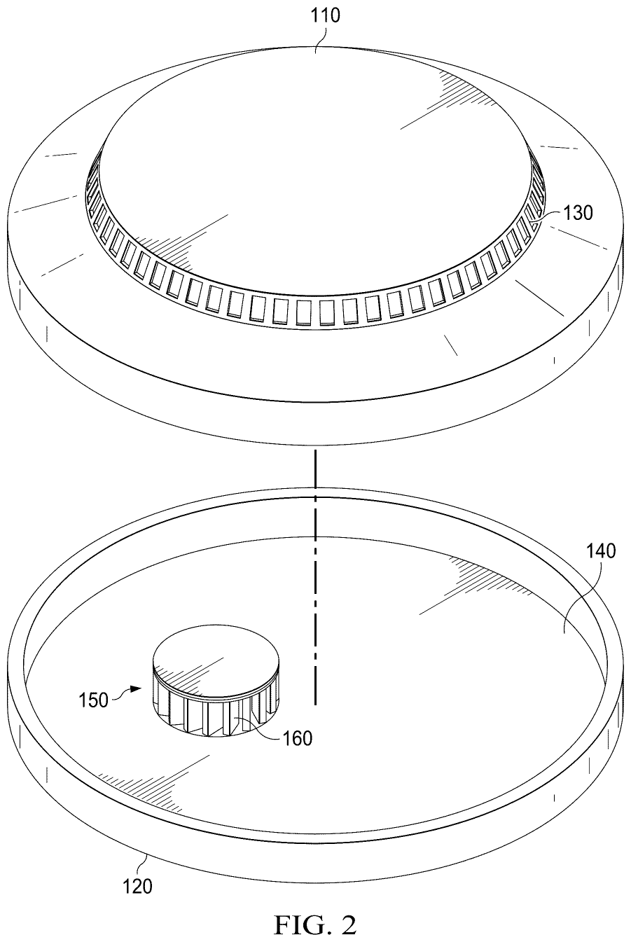

FIG. 2 illustrates an exploded view of the monitoring system 100. As shown in FIG. 2, the external housing top 110 and the external housing base 120 may be separate parts defining an interior. The monitoring system 100 includes a printed circuit board (PCB) 140. PCB 140 provides a mounting surface for an internal housing 150 defining a baffled test chamber. The internal housing 150 shown includes a set of passageways 160 allowing air or other fluid to flow from outside the internal housing 150 to an interior thereof.

In some systems, there may be a mounting surface that is not a PCB. For example, the internal housing 150 may be mounted directly to either the external housing top 110 or the external housing base 120. As another example, the internal housing 150 may be mounted to different elements of the system.

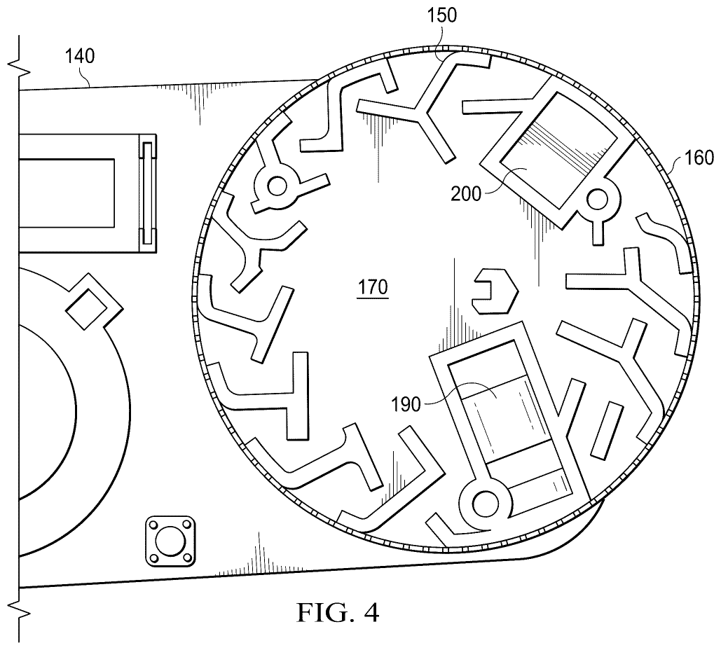

PCB 140 may include circuitry or leads to provide power and/or signals to components of the internal housing 150. As an example, a processor may be mounted to the PCB 140 and connected to the internal housing 150 by printed circuits or conductive tracks on the PCB 140 (described in more detail in relation to FIG. 4).

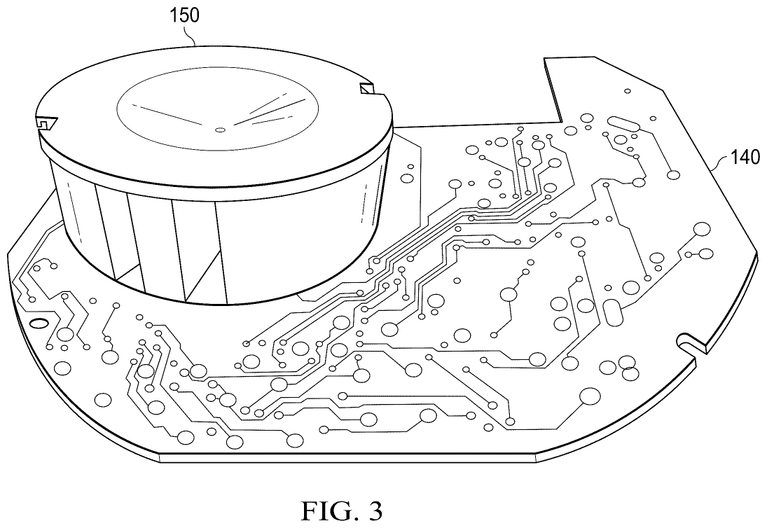

FIG. 3 is a drawing showing an internal housing 150 mounted on a PCB 140. FIG. 4 is a drawing showing the internal housing 150 with a portion removed showing a plurality of passageways 150 and a test chamber 160. As shown in FIG. 4, the internal housing 150 may be surrounding by a mesh restricting the entry of some particles into the internal housing 150 and/or the test chamber 160.

The internal housing 150 may include any combination of inlets or outlets appropriate for allowing air flow into the test chamber 170. As shown in FIG. 4, the internal housing 150 defines the test chamber 170 for the monitoring system 100. The plurality of passageways 160 may include baffles configured to allow air flow (along with any entrained particles) into the test chamber 170 while restricting and/or blocking the entrance of light from outside the monitoring system 100. When the monitoring system 100 comprises a smoke detector, the baffles may deflect some or all ambient light from outside the monitoring system 100, providing a dark test chamber 170 for a photochamber-style smoke detector. Some or all of the individual passageways 160 may become occluded with dust or other debris over time.

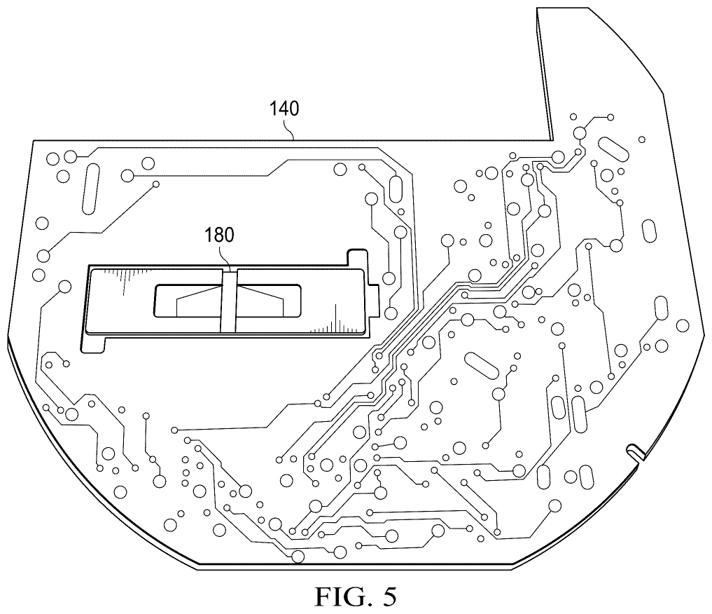

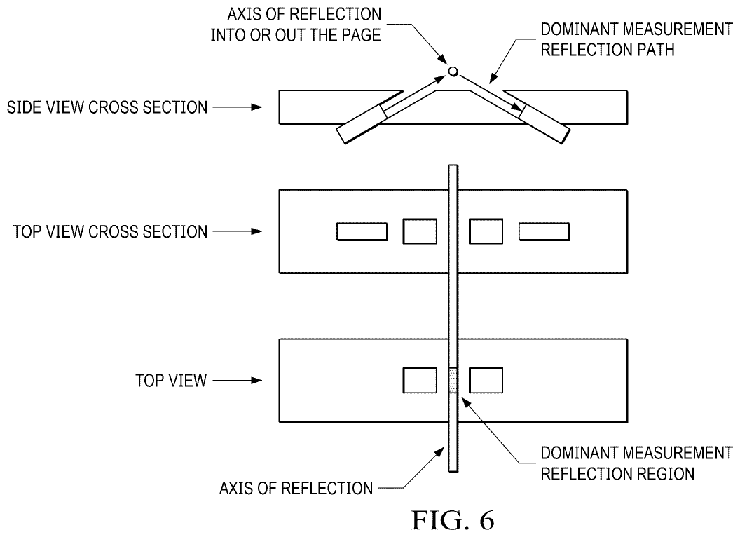

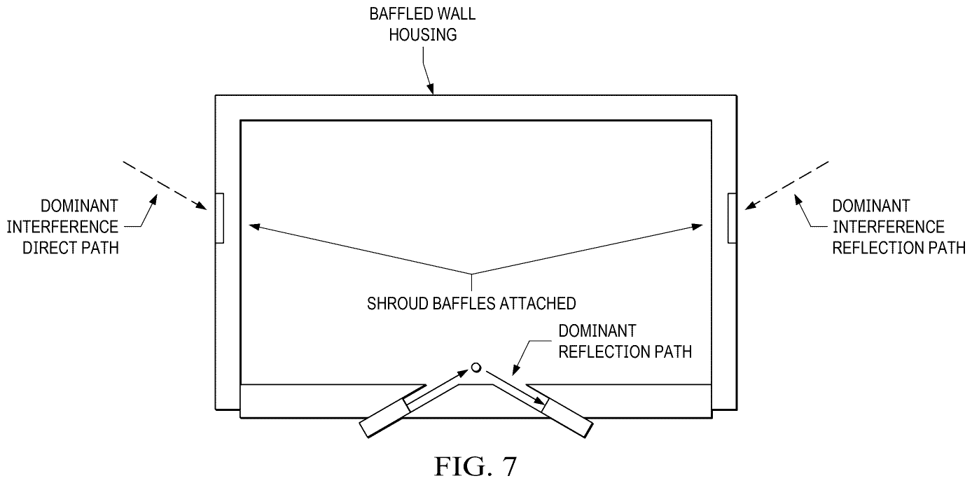

FIG. 5 is a drawing of internal components of an example system incorporating teachings of the present disclosure. FIG. 5 shows PCB 140 from FIG. 3 with the internal housing 150 removed. Base 180 is fixed to PCB 140. Base 180 includes fittings for a source 190 and a sensor element 200. Although FIG. 5 shows the source 190 and sensor element 200 in a particular arrangement, the positions of the two elements relative to the PCB may be changed. The relation between the source 190 and the sensor element 200, however, is discussed in more detail with relation to FIGS. 6 and 7. Base 180 may also include various connection points for the internal housing 150.

As shown, the PCB 140 is at the bottom of the internal housing 150. As described with relation to FIG. 1, however, this orientation is described only in relation to the depiction and does no limit the orientation of the monitoring system 100 in operation. Light generated by the source 190 enters the internal housing 150 at an upward angle from the bottom and, thereby, the test chamber 170. If any particles are present in the test chamber 170, the light may be reflected back downward to the sensor element 200, indicating the presence of smoke.

In some monitoring systems, the source 190 and the sensor element 200 may be aligned parallel to one another along the bottom of the test chamber 170 and/or the PCB 140. In such monitoring systems, the source 190 and the sensor element 200 may be disposed at an angle to one another along the plane of the test chamber 170. For example, as shown in FIG. 4, the source 190 and the sensor element 200 are aligned at an angle in the plane of the test chamber 170 instead of at an upward angle from the bottom of the test chamber 170.

The source 190 and the sensor element 200 may comprise any compatible light source and light sensing element useful for detecting smoke particles, in the case of a smoke detector. In other examples, the combination of the source 190 and the sensor element 200 may be selected based on the particles of interest. The sensor element 200 may generate a signal represented an illuminance resulting from light impacting the sensor element 200.

FIG. 6 is a schematic drawing of internal components of an example system incorporating teachings of the present disclosure. FIG. 6 shows an example base 180 in side view at a cross section. As shown, base 180 provides a housing for the source 190 and the sensor element 200. Further, FIG. 6 shows the axis of reflection perpendicular to the page. The dominant measurement reflection path is defined by the angle of the light emitted by the source 190 reflected at the axis of reflection. FIG. 6 also shows a cross section of the base 180 in top view showing the source 190 and the sensor element 200. FIG. 6 also shows a top view of the base 180 with the axis of reflection above the base 180.

FIG. 7 is a schematic drawing of internal components of an example system incorporating teachings of the present disclosure. FIG. 7 shows a cross section through the internal housing 150 and the base 180 at the same location as FIG. 6. As shown, the dominant reflection path as defined in the description of FIG. 6 is extended to define the dominant interference direct path. The original orientation of the source 190 can likewise be extended to define the dominant interference reflection path. In this example, a “dominant interference” path refers to a path which increases noise in the signal at the sensor element 200 at a higher relative rate for the same light intensity compared to other paths.

As shown in FIG. 7, the internal housing 150 includes shroud baffles 210 attached at the intersection of the identified dominant interference paths and the internal housing 150. The shroud baffles 210 provide additional protection against external light entering the test chamber 170 along the dominant interference paths and thereby reduce potential noise or interference with operation of the monitoring system 100.

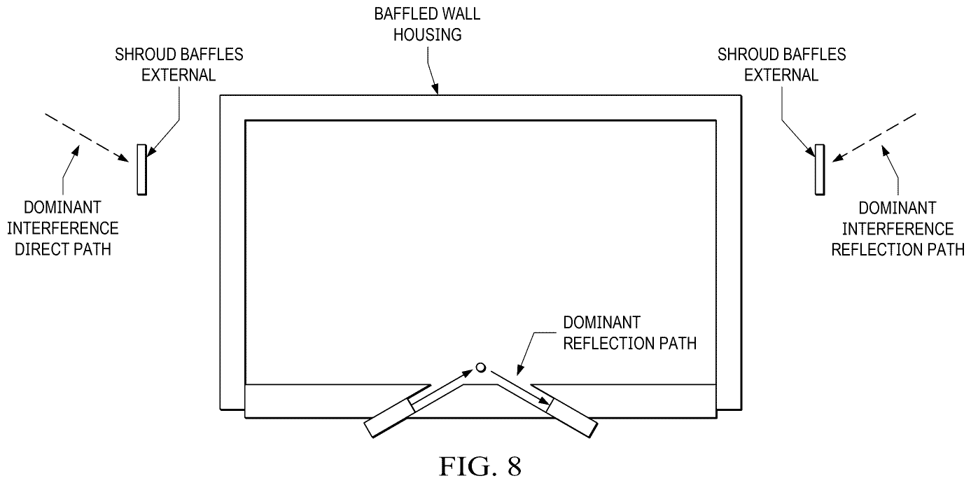

FIG. 8 is a schematic drawing of internal components of an example system incorporating teachings of the present disclosure. FIG. 8 shows a cross section through the internal housing 150 and the base 180 at the same location as FIG. 6. As shown, the dominant reflection path as defined in the description of FIG. 6 is extended to define the dominant interference direct path. The original orientation of the source 190 can likewise be extended to define the dominant interference reflection path. In this example, a “dominant interference” path refers to a path which increases noise in the signal at the sensor element 200 at a higher relative rate for the same light intensity compared to other paths.

As shown in FIG. 8, the internal housing 150 includes shroud baffles 210 mounted outside the internal housing 150 along the identified dominant interference paths. The shroud baffles 210 provide additional protection against external light entering the test chamber 170 along the dominant interference paths and thereby reduce potential noise or interference with operation of the monitoring system 100.

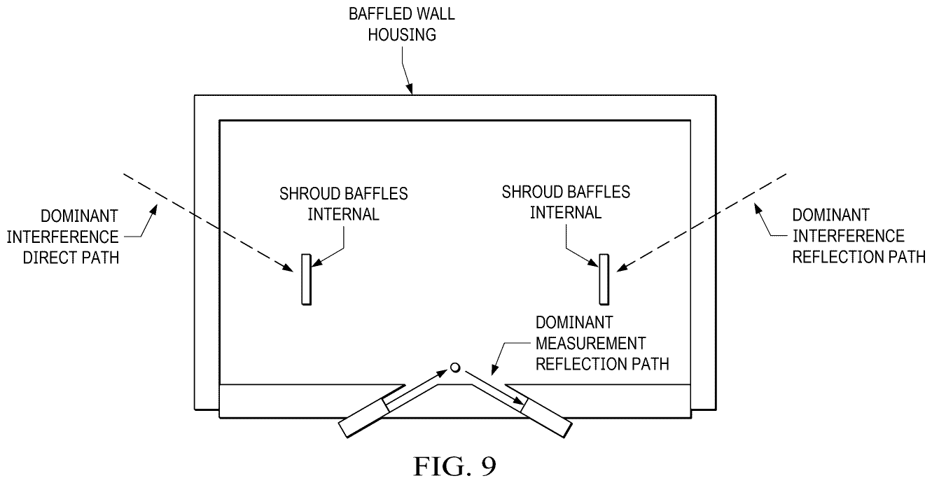

FIG. 9 is a schematic drawing of internal components of an example system incorporating teachings of the present disclosure. FIG. 9 shows a cross section through the internal housing 150 and the base 180 at the same location as FIG. 6. As shown, the dominant reflection path as defined in the description of FIG. 6 is extended to define the dominant interference direct path. The original orientation of the source 190 can likewise be extended to define the dominant interference reflection path. In this example, a “dominant interference” path refers to a path which increases noise in the signal at the sensor element 200 at a higher relative rate for the same light intensity compared to other paths.

As shown in FIG. 9, the internal housing 150 includes shroud baffles 210 present along the identified dominant interference paths and inside the internal housing 150. The shroud baffles 210 provide additional protection against external light entering the test chamber 170 along the dominant interference paths and thereby reduce potential noise or interference with operation of the monitoring system 100.

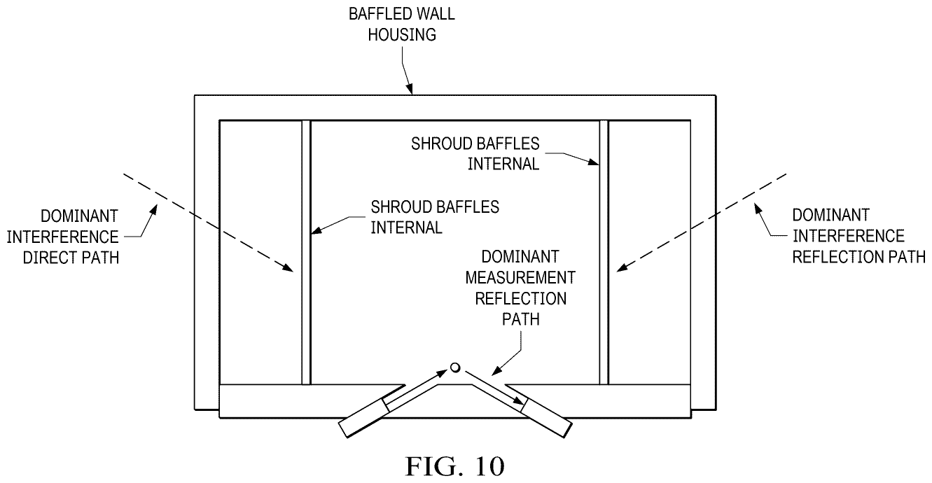

FIG. 10 is a schematic drawing of internal components of an example system incorporating teachings of the present disclosure. FIG. 10 shows a cross section through the internal housing 150 and the base 180 at the same location as FIG. 6. As shown, the dominant reflection path as defined in the description of FIG. 6 is extended to define the dominant interference direct path. The original orientation of the source 190 can likewise be extended to define the dominant interference reflection path. In this example, a “dominant interference” path refers to a path which increases noise in the signal at the sensor element 200 at a higher relative rate for the same light intensity compared to other paths.

As shown in FIG. 10, the internal housing 150 includes baffles 210 crossing the identified dominant interference paths and extending from the bottom of the internal housing 150 to the top of the internal housing 150. The shroud baffles 210 provide additional protection against external light entering the test chamber 170 along the dominant interference paths and thereby reduce potential noise or interference with operation of the monitoring system 100.

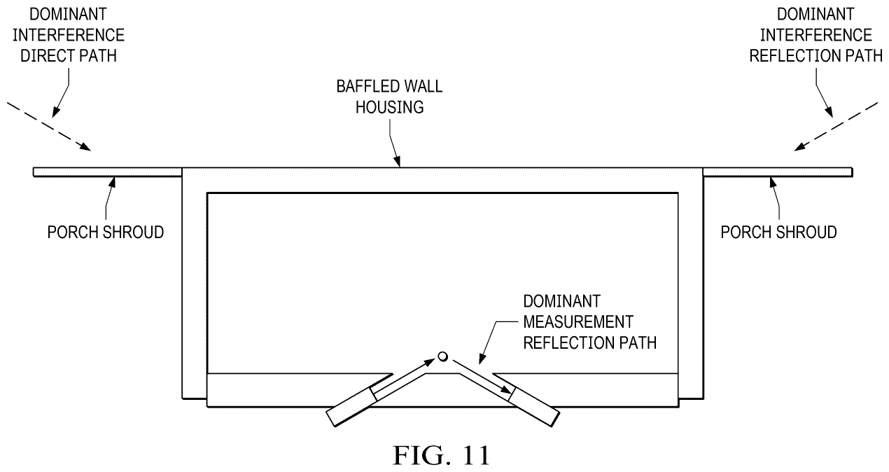

FIG. 11 is a schematic drawing of internal components of an example system incorporating teachings of the present disclosure. FIG. 11 shows a cross section through the internal housing 150 and the base 180 at the same location as FIG. 6. As shown, the dominant reflection path as defined in the description of FIG. 6 is extended to define the dominant interference direct path. The original orientation of the source 190 can likewise be extended to define the dominant interference reflection path. In this example, a “dominant interference” path refers to a path which increases noise in the signal at the sensor element 200 at a higher relative rate for the same light intensity compared to other paths.

As shown in FIG. 11, the internal housing 150 includes porch shrouds extending radially from the top of the internal housing 150 and intersecting the identified dominant interference paths. The porch shrouds provide additional protection against external light entering the test chamber 170 along the dominant interference paths and thereby reduce potential noise or interference with operation of the monitoring system 100.

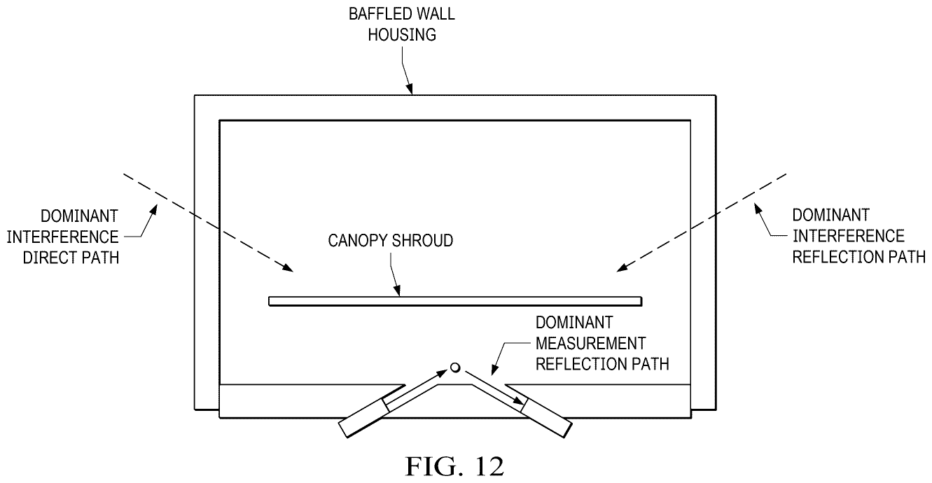

FIG. 12 is a schematic drawing of internal components of an example system incorporating teachings of the present disclosure. FIG. 12 shows a cross section through the internal housing 150 and the base 180 at the same location as FIG. 6. As shown, the dominant reflection path as defined in the description of FIG. 6 is extended to define the dominant interference direct path. The original orientation of the source 190 can likewise be extended to define the dominant interference reflection path. In this example, a “dominant interference” path refers to a path which increases noise in the signal at the sensor element 200 at a higher relative rate for the same light intensity compared to other paths.

As shown in FIG. 12, the internal housing 150 includes a canopy shroud extending within the internal housing to cross the identified dominant interference paths. The canopy shroud extends parallel to the base of the internal housing 150. The canopy shroud provides additional protection against external light entering the test chamber 170 along the dominant interference paths and thereby reduces potential noise or interference with operation of the monitoring system 100.

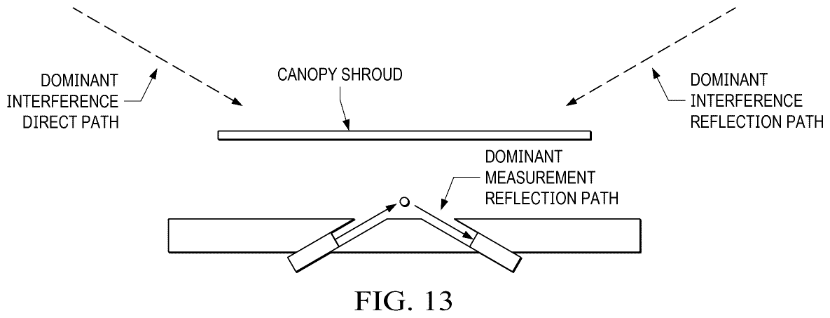

FIG. 13 is a schematic drawing of internal components of an example system incorporating teachings of the present disclosure. FIG. 13 shows a cross section through an alternate example of a monitoring system with no internal housing. The monitoring system includes a base 180 with a light source and sensor element disposed at the same location as FIG. 6. In the contrast to the monitoring system represented in FIG. 6, the monitoring system has no internal housing but operates with a functional test volume into which the light source emits light and the sensor element measures illuminance. As shown, the dominant reflection path as defined in the description of FIG. 6 is extended to define the dominant interference direct path. The original orientation of the source can likewise be extended to define the dominant interference reflection path. In this example, a “dominant interference” path refers to a path which increases noise in the signal at the sensor element at a higher relative rate for the same light intensity compared to other paths.

As shown in FIG. 13, given there is no internal housing, the canopy shroud shown therein blocks light approaching the sensor along both the dominant interference direct path and the dominant interference reflection path. The canopy shroud provides a reduction in external light entering the test volume along the dominant interference paths and thereby reduces potential noise or interference with operation of the monitoring system.

We claim:

1. A system comprising:
a housing defining an internal test chamber;
a sensor element exposed to the internal test chamber to generate a signal representing an illuminance;
one or more passageways allowing air flow into the internal test chamber from a surrounding area; and
a shroud blocking entrance of light into the internal test chamber through the one or more passageways along a dominant interference path to reduce noise in the illuminance signal.

2. The system as recited in claim 1, wherein the shroud is mounted in the one or more passageways.

3. The system as recited in claim 1, wherein the shroud is mounted outside the housing.

4. The system as recited in claim 1, wherein:
the sensor element is mounted in a bottom of the housing; and
the shroud is mounted outside the housing extending radially from a top of the housing opposite the bottom of the housing.

5. The system as recited in claim 1, wherein the shroud is mounted within the internal test chamber.

6. The system as recited in claim 5, wherein the shroud extends from a top of the internal test chamber to a bottom of the internal test chamber.

7. The system as recited in claim 5, wherein:
the sensor element is mounted in a base of the housing; and
the shroud extends parallel to the base.

8. The system as recited in claim 1, further comprising a source emitting light into the internal test chamber.

9. The system as recited in claim 1, further comprising a source emitting light into the internal test chamber;
wherein an orientation of the light source with respect to the sensor element defines an axis of reflection; and
the dominant interference path comprises a dominant interference direct path through the axis of reflection to the sensor element.

10. The system as recited in claim 1, further comprising a source emitting light into the internal test chamber;
wherein an orientation of the light source with respect to the sensor element defines an axis of reflection; and
the dominant interference path comprises a dominant interference reflection path through the axis of reflection to the light source.

11. The system as recited in claim 1, further comprising:
a printed circuit board (PCB) with a base; and
a source disposed within the base;
wherein the sensor element is disposed within the base;
the internal housing is mounted to the PCB;
the source emits light from the base into the internal test chamber; and
the illuminance measured by the sensor element detects light reflected from inside the internal test chamber to the sensor element.

12. A system comprising:
a light source emitting light into a test volume;
a sensor element exposed to light in the test volume to generate a signal representing an illuminance; and
a shroud reducing entrance of light into the test volume along a dominant interference path to reduce noise in the illuminance signal.

13. A system as recited in claim 12, wherein:
the light source and sensor element are mounted in a base;
the shroud extends parallel to and separated from the base.

14. A system as recited in claim 12, wherein:
an orientation of the light source with respect to the sensor element defines an axis of reflection; and
the dominant interference path comprises a dominant interference direct path through the axis of reflection to the sensor element.

15. The system as recited in claim 12, further comprising:
a printed circuit board (PCB); and
a base disposed within the PCB; and
wherein the illuminance measured by the sensor element detects light reflected from inside the test volume to the sensor element.

16. The system as recited in claim 12, wherein:
the light source and the sensor element are mounted in a base; and
the shroud extends from the base.

17. The system as recited in claim 16, wherein the shroud extends orthogonal to the base.
